(19) United States
(12) Patent Application Publication
(10) Pub. No.: US 2026/0033425 A1
(43) Pub. Date: Feb. 5, 2026

(54) COMBINE HARVESTER AND METHOD FOR OPERATING A COMBINE HARVESTER

(71) Applicant: CLAAS Selbstfahrende Erntemaschinen GmbH, Harsewinkel (DE)

(72) Inventors: Bastian Bormann, Gutersloh (DE); Andreas Wilken, Bissendorf (DE); Henner Vöcking, Rietberg (DE); Matthias Domnik, Oelde (DE); Waldemar Thiesmann, Osnabrück (DE); Tarek Kösters, Köln (DE)

(73) Assignee: CLAAS Selbstfahrende Erntemaschinen GmbH, Harsewinkel (DE)

(21) Appl. No.: 19/286,895

(22) Filed: Jul. 31, 2025

(30) Foreign Application Priority Data
Jul. 31, 2024 (DE) 10 2024 121 759.6

(51) Int. Cl. A01D 41/127

(52) U.S. Cl. CPC A01D 41/1274

(57) ABSTRACT

A combine harvester. The combine harvester includes a plurality of working units and a driver assistance system for controlling the working units. The driver assistance system comprises a memory for saving data and a computing device for processing the data saved in the memory. The working units and the driver assistance system form a setting machine in that a plurality of selectable harvesting process strategies are saved in the memory, and in that the computing device autonomously determines at least one setting parameter for the implementation of the selected harvesting process strategy and specifies it to the working units. An overall model per target variable is saved in the memory and forms functional relationships between the target variable and a plurality of influencing variables, which comprise internal and external influencing variables. The computing device performs the autonomous determination of the at least one setting parameter based on the overall model.

### CROSS REFERENCE TO RELATED APPLICATION

This application claims priority under 35 U.S.C. § 119 to German Patent Application No. DE 10 2024 121 759.6 filed Jul. 31, 2024, the entire disclosure of which is hereby incorporated by reference herein.

### TECHNICAL FIELD

The present invention relates to a combine harvester and a method for operating a combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Combine harvesters may be used for mowing and threshing cereals as harvested material. For this purpose, the combine harvester may comprise a plurality of working units for performing specific sub-work processes of an overall working process for processing the harvested material. For example, threshing may be performed by a threshing device, which may extract grain from the harvested material picked up or collected by the combine harvester using an attachment, such as a cutting unit. After threshing, the grain may be fed to a separating device in order to be separated, subsequently cleaned by a cleaning device, and then transferred to a grain tank. The chaff and the straw, for example, may remain as further components of the harvested material, which may either be distributed over the field together with the straw comminuted by a chopping apparatus or, in the case of the straw, placed in a windrow, for example to be later collected by a baler. Adjusting or modifying the various working units may place high demands on an operator since changes to a setting parameter may affect other setting parameters or process quality parameters within a working unit. For example, increasing the rotational speed of a threshing drum of the threshing device may lead to an increase in the throughput of harvested material, while at the same time increasing the broken grain portion.

US Patent Application Publication No. 2019/0343044 A1, incorporated by reference herein in its entirety, discloses a combine harvester that includes a driver assistance system for controlling the working units and which includes a memory for saving data, a computing device for processing the data saved in the memory, and a graphical user interface (e.g., a touchscreen). The combine harvester may further include a setting machine to control the separating device and the cleaning device. It is also provided that a process supervisor is assigned to the driver assistance system to control individual setting machines and to exchange data between the setting machines. The process supervisor may have the task of optimizing the overall working process in that the process supervisor specifically influences or modifies operation of the setting machines.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example schematic representation of a combine harvester in a side view.

FIG. 2 illustrates an example schematic representation of the functional principle of the driver assistance system.

FIG. 3 illustrates an example schematic representation of the functional principle of the setting machine.

FIG. 4 illustrates an example schematic representation of the functional principle of the setting machine with several overall models according to one embodiment.

### DETAILED DESCRIPTION

As discussed in the background, the combine harvester may include a process supervisor that has the task of optimizing the overall working process to specifically influence the setting machines. However, a combine harvester with a process supervisor may have a complex structure. In this regard, improvements to this situation may be desirable.

In one or some embodiments, a combine harvester is disclosed with a driver assistance system with efficient overall machine control. Specifically, the combine harvester may include a plurality of working units and a driver assistance system configured to control the plurality of working units. The driver assistance system comprises a memory for saving data and a computing device for processing the data saved in the memory. Together with the driver assistance system, the plurality of working units may form a setting machine, in that a plurality of selectable harvesting process strategies are saved in the memory, and in that the computing device is configured to autonomously determine at least one setting parameter for implementing the selected harvesting process strategy and to specify it to one or more of the plurality of working units (such as to the plurality of working units as a whole). An overall model for each target variable may be saved in the memory, wherein the overall model forms functional relationships between the target variable (e.g., a respective target variable) and several influencing variables. The influencing variables may include internal influencing variables and external influencing variables. The computing device is configured to perform the autonomous determination of the at least one setting parameter (such as one, some, or all setting parameters) based on the overall model.

The driver assistance system may be an additional electronic apparatus in the combine harvester to support the operator or driver. The driver assistance system may be designed as semi-autonomous or autonomous. Further, the driver assistance system may be directly connected to the plurality of working units (e.g., the driver assistance system may issue one or more commands, transmitted wired and/or wirelessly, in order to control one, some, or each of the plurality of working units).

In one or some embodiments, a harvesting process strategy may refer to a planned and systematic approach to optimize the harvesting of agricultural products. The harvesting process strategy may include selecting one, some, or each of the best time, the appropriate methods and the necessary equipment to maximize the quality and quantity of the harvest. By selecting a harvesting process strategy once, a way of controlling the working units may be specified (and need not be revisited by the operator). In this regard, further input from the operator need not be required to determine the setting parameters. However, the operator or driver may have the option of changing the selected harvesting process strategy if desired so that autonomous control may then continue to occur, but potentially with a different prioritization.

The autonomous determination of the at least one setting parameter may refer to the ability of the setting machine to independently determine one, some or all setting parameters that are necessary for the optimal operation of the agricultural machine without human intervention. This may be done by using algorithms and/or machine learning to automatically analyze current conditions and make appropriate adjustments. The setting parameters may be used to automatically adjust the plurality of working units.

The setting machine may automatically control one or more of the plurality of working units, for example by automatically transmitting an electrical signal (e.g., a command) from the setting machine to a respective working unit or to the plurality of working units. The electrical signal may include information that enables the working unit to automatically perform a partial work process. For example, the information may cause the working units to automatically start the subprocess. In other words, the control may mean directly influencing the behavior of the working units using the setting parameters.

In one or some embodiments, a single setting machine may be provided for overall automatic control of the plurality of working units, wherein the single setting machine may be designed as an independently operating unit. In this regard, the agricultural work machine may have a single setting machine. As a stand-alone unit, the setting machine may fulfill its tasks and objectives independently and without continuous external control. Overall control may mean that all working units are automatically controllable or may be automatically controlled simultaneously. For example, using the setting machine, all the setting parameters for the agricultural work machine and/or working units (such as all of the working units of the agricultural work machine) may be automatically determined together. The setting machine may have the necessary autonomy, resources and responsibility to work independently and achieve its results. In one or some embodiments, the setting machine may be understood as a combination or standardization of a plurality of individual machines (e.g., any one, any combination, or all of front attachment machine unit, threshing machine, separating machine, cleaning machine, or a distribution machine). It is contemplated for the setting machine to automatically control several working units simultaneously as a whole. In other words, a plurality of machines, each of which being assigned to a subprocess, may be combined into one setting machine. This may make it possible for a large number of machines to be unnecessary and instead use only one setting machine, which may potentially control all the sub-work processes of an overall work process for processing harvested materials. In this way, it may be possible to dispense with a process supervisor because the process supervisor may no longer be necessary. Advantages of the setting machine may include improved clarity, simple maintenance and updates, increased efficiency, cost savings, improved data integration, better communication and collaboration, scalability and increased safety.

The setting machine may be given the task of automatically optimizing the overall work process by exerting a targeted influence on the working units. The setting machine may optimize the automatic control of the working units. In one or some embodiments, optimizing the control of working units may relate to the improvement of the control processes and mechanisms that regulate the operation and coordination of the combine harvester (or system components) in order to maximize its efficiency, accuracy and performance. Thus, the setting machine may contribute to a fast and robust control of the working units.

In one or some embodiments, the target variable of the setting machine may be a variable or a signal that is generated as the result of a model calculation or simulation. The setting machine or the computing device may be configured to automatically access the overall model, wherein the overall model provides the target variable.

Based on this functional relationship of the overall model, it is contemplated, depending on different operating situations, to automatically draw conclusions about setting parameters that enable optimized execution of the sub-work process or that enable the target of a harvesting process strategy to be achieved. In one or some embodiments, the overall model may have a plurality of influencing variables as inputs. Furthermore, the overall model may have the target variable as an output. In other words, in one or some embodiments, a MISO system (multiple input, single output) may be provided for the setting machine.

In one or some embodiments, the influencing variables may be factors acting on a combine harvester that may affect the combine harvester and determine the efficiency and performance of the machine. Internal influencing variables may refer to factors acting from the inside and may relate to any one, any combination, or all of engine capacity, cutterbar width, threshing drum rotational speed, sieve settings, and the condition of wearing parts. External influencing variables may relate to factors acting on the combine harvester from the outside and may relate to any one, any combination, or all of the condition of the harvested material (such as moisture content and/or stalk strength), the soil conditions, the weather (temperature and/or precipitation), and the terrain profile of the field. Influencing variables may affect the working conditions and therefore the performance and energy consumption of the combine harvester. Optimum interaction between these influencing variables may be decisive for an efficient harvest.

The working units may be configured to perform specific sub-work processes of an overall work process to process harvested material. In so doing, each working unit may be assigned a specific sub-work process.

A sub-work process may be, for example, a threshing process, a separating process or a cleaning process. The overall work process may comprise a plurality of the sub-work processes. The overall work process may relate to all steps for processing harvested materials (e.g., threshing, separating, cleaning, etc.). In one or some embodiments, for each sub-work process, the functional relationships may be saved in the memory of the driver assistance system, which may be accessed by the (e.g., single) setting machine to autonomously determine the setting parameters of the corresponding working unit. In so doing, the functional relationships may be continuously, dynamically and automatically adjusted to the current harvesting process status in ongoing harvesting mode.

In one or some embodiments, the memory for saving data may be a conventional digital storage medium, such as a storage drive. Saved data may be information that is saved in the memory of the driver assistance system in order to control and optimize its operation and/or the operation of the combine harvester. This data may include any one, any combination, or all of setting parameters, control parameters, commands, or other signals for control.

In one or some embodiments, a combine harvester may include selectable harvesting process strategies that each address the target specification of the setting or optimization of a target variable such as any one, any combination, or all of “threshing losses”, “broken grain portion”, “separation losses”, “cleaning losses”, “threshing unit drive slip”, “fuel consumption” by a corresponding specification of influencing variables.

A cleaning loss may be an unwanted separation of grain during the cleaning process of the combine harvester. Separation losses may be the unwanted loss of grain during the separation process, such as due to incomplete separation of grain from straw or other plant materials.

Other target variables may be the overflow volume, the grain fraction overflow, material other than grain, or broken grain. The overflow volume may be the amount of harvested material that falls over the edges of the cutterbar or sieves on the sides of the combine during the threshing and cleaning process. The grain fraction overflow may be the amount of grain that is lost through the sieves of the combine harvester during the threshing process and does not reach the grain tank.

Material other than grain (MOG) or foreign matter may be unwanted materials such as straw, leaves or weeds that are harvested along with the grain during the threshing and cleaning process. Broken grain may be damaged or broken grains that arise during the threshing and separation process and may reduce the quality of the harvested grain.

In one or some embodiments, a combine harvester may have the target variable being assigned to at least one characteristic curve field for mapping the functional relationships, wherein the target variable may be formed on the basis of an output variable of the at least one characteristic curve field.

One advantage of assigning the target variable to at least one characteristic curve field may be that precise and data-based optimization is made possible. As a result, deviations and inefficient operating states may be detected, and automatically and dynamically corrected early on.

In one or some embodiments, the combine harvester uses the internal influencing variables, which may comprise a working unit parameter, and wherein the working unit parameter may be formed as any one, any combination, or all of the following: a threshing drum rotational speed; a threshing concave width; a rotor rotational speed; a fan rotational speed; a position of a rotor cover; a position of a flap opening; a position of a top sieve; or a position of a bottom sieve.

In other words, a working unit parameter or machine parameter of the combine harvester may potentially comprise an influencing variable of the setting machine. The setting machine may transmit parameters, such as the setting parameters or other signals, for example, after a calculation or optimization, to other devices of the agricultural work machine or combine harvester.

In one or some embodiments, the combine harvester may use the external influencing variables, which may comprise a harvested material parameter, and wherein the harvested material parameter may be formed as any one, any combination, or all of the following: a crop density; a threshability; or a crop moisture.

In one or some embodiments, the combine harvester may use the overall model, which is based on a regularized model. An overall model may be, for example, a mathematical model. The mathematical model, such as a regression model, may be an abstract representation of a real system or process that may be described by mathematical equations or formulas. In one or some embodiments, the mathematical model or the coefficients of a mathematical model may be determined using the method of least squares, such as shown in the following:

$$\hat{c} = {( {X}^{T} X )}^{- 1} {X}^{T} y$$

A regularized model may refer to a model that contains special control or regulation elements to influence or optimize the system behavior. Additional terms or parameters that model and regulate the dynamics or stability of the system may be in a regularized model, such as shown in the following:

$$\hat{c} = {( {X}^{T} X + λ R )}^{- 1} ( {X}^{T} y + λ {c}^{*} )$$

The regularized model or regression model may offer several advantages. It may avoid overfitting in that it may reduce model complexity, for example through lasso regularization which sets some coefficients to zero, or ridge regularization which penalizes large coefficients. This may also improve model interpretability, as only the most important features would be selected. In addition, the stability of the estimates may be increased since the model would be less susceptible to small changes in the training data. Regularization may also help mitigate problems with multicollinearity and therefore lead to more stable estimates. A regularized model may generalize better and therefore may show improved predictive performance on test data. In addition, the regularized model may avoid extremely large coefficients and therefore may create a more stable and realistic model. Finally, computational efficiency may be ensured by optimized algorithms, which may be particularly of advantage for large data sets.

In one or some embodiments, the combine harvester may comprise an actuator system. The actuator system may include a plurality of actuators, wherein the plurality of actuators may be connected to (or in wired and/or wireless communication with) the setting machine, and wherein one or more of the working units may be controlled using a respective actuator.

In one or some embodiments, the computing device may be connected to (e.g., in wired and/or wireless communication with) the actuator system or the plurality of actuators. Accordingly, the computing device may transmit signals, commands or information about or indicative of the setting parameters to the actuator system. In turn, the respective actuator, implementing the respective setting parameter, may control the respective working unit.

In one or some embodiments, an actuator may comprise a drive unit that converts an electrical signal (e.g., commands issued by the driver assistance system) into mechanical movements or changes in physical variables (e.g., pressure or temperature) and therefore actively intervenes in a controlled process. Examples of actuators may include valves, cylinders (e.g., pneumatic cylinders, hydraulic cylinders, electric cylinders), electromechanical drives, electric motors or piezo elements. In one or some embodiments, the respective actuator may be part of the working unit or embedded in the working unit. For example, the actuator may be a hydraulic motor that drives the threshing drum of the combine harvester.

In one or some embodiments, the combine harvester includes the computing device that cyclically, periodically, and/or dynamically adjusts the overall model to a current harvesting process state during harvesting mode. The automatic adjustment of the overall model may be triggered in one or more ways. In one or some embodiments, the trigger may be responsive to determining or detecting the harvesting process state (such as the current harvesting process state). In one or some embodiments, the combine harvester includes a sensor array, which is configured to generate sensor data for detecting or indicative of at least a part of the harvesting process state.

In one or some embodiments, the cyclical adjustment to a current harvesting process state may mean that the current state of the harvesting process is checked at regular, recurring intervals and compared with the desired or optimum operating conditions. This adjustment may occur continuously during the harvesting process to ensure that all parameters and settings of the combine harvester are optimally adjusted to the current conditions and requirements. In one or some embodiments, this may mean continuous adjustment and optimization of operation to maximize efficiency and performance.

In one or some embodiments, the sensor array may include a plurality of sensors. Various sensors are contemplated. For example, the sensor may be a technical component configured to detect certain physical or chemical properties (physical (such as an amount of any one, any combination or all of heat, temperature, humidity, pressure, sound field sizes, brightness, or acceleration) or chemical) and/or the material nature of its environment qualitatively or quantitatively as a measured variable. Data detected by a sensor may be transmitted (e.g., wired and/or wirelessly) to the setting machine and/or the computing device. In turn, the setting machine may perform calculations using the data detected or sensed by the sensor. In one or some embodiments, the inputs of the overall model or the mathematical model may comprise the data detected by the sensor. Furthermore, in one or some embodiments, the internal influencing variables and/or the external influencing variables may be detected using the sensor array.

In one or some embodiments, the combine harvester includes the sensor array, which may comprise any one, any combination, or all of a separation loss sensor, a cleaning loss sensor, a broken grain sensor, or a threshing loss sensor.

Thus, in one or some embodiments, the harvesting process parameters may include any one, any combination, or all of “threshing losses”, “broken grain portion”, “layer height”, “separation losses”, “cleaning losses”, “threshing unit load”, or “fuel consumption”, which may be detectable using at least one sensor of the sensor array.

In one or some embodiments, the combine harvester includes the threshing device, a separating device and a cleaning device as working units. Alternatively, or in addition, the combine harvester includes the driver assistance system that forms a setting machine with a threshing device, a separating device and a cleaning device.

In one or some embodiments, at least one front attachment and/or a distribution apparatus may comprise working units. Further examples of a working unit may be a separating device, which may be designed as a straw walker or as an axial separating device with one or two separating rotors, or a distribution apparatus. The distribution apparatus may comprise a chaff spreading device, a chopping apparatus and/or a distribution apparatus for distributing at least the harvested material provided by the chopping apparatus.

One advantage of combining the threshing device, the separating device and the cleaning device into a single setting machine may be that fewer calculations are required or that the calculation may be performed more easily. In addition, these devices may have the same influencing variables, which may be better detected and analyzed using the single setting machine rather than using a plurality of individual machines. The setting machine may form a higher-level unit that may simultaneously and automatically monitor and control the operation of each of the threshing device, the separating device and the cleaning device.

In a further aspect, a computer-implemented method for training a setting machine is disclosed. In this case, the setting machine may perform the overall control of working units of the combine harvester. The computer-implemented method may comprise: acquiring training data, (wherein the training data may be automatically detected during operation of the combine harvester); and training the setting machine (e.g., using minimizing a loss function, wherein the loss function is determined based on a single output variable of the setting machine and the training data).

In a further aspect, a computer-implemented method for optimizing an operating point of a combine harvester uses a single setting machine. The computer-implemented method may comprise: training the single setting machine using the method disclosed above; automatically determining setting parameters based on the trained setting machine; and automatically controlling one, some or all of the plurality of working units of the combine harvester based on the setting parameters.

The setting parameters may, for example, be determined in such a way that the influencing variables or input variables of the setting machine are varied. In so doing, the influencing variables may be varied until the target variable assumes a predetermined minimum value.

In one or some embodiments, the at least one control process may be saved in the memory of the driver assistance system. The at least one control process may be based on a set of rules or a controller structure. Setting parameters may be understood as working-unit-specific machine parameters for setting harvested material handling means by at least one actuator assigned to the harvested material handling means, which may be determined independently by the setting machines. Setting parameters of the front attachments or cutting unit working unit may be, among other things, cutterbar height, cutting angle, reel position and the like. In the case of the cutting unit, harvested material handling means may, for example, be cutter bars, reels, feed rollers and the like, to which an actuator may be assigned in order to set and/or operate these harvested material handling means. In the case of the cutterbar working unit, the term process quality parameters may mean pick-up losses, cut head losses, spraying grain losses, etc. Process quality parameters may be an evaluation criterion for an optimum setting of the working unit by the setting machine. The same may apply to the other working units of the combine harvester provided for carrying out sub-work processes.

The setting machine may be configured to optimize the overall work process during operation of the combine harvester in partial load mode. For example, the “maximum throughput” harvesting process strategy cannot be achieved due to partial load mode caused by the driving speed. In order to nevertheless optimize the overall work process within the framework of such boundary conditions, the setting machine may automatically shift or redefine priorities.

In one or some embodiments, the driver assistance system may be included in or work in combination with a combine harvester. It is also contemplated for the driver assistance system to be used in another agricultural work machine, such as a forage harvester.

In general, the disclosed method may also apply to a corresponding device for performing the method or a corresponding system that comprises one or more devices, and vice versa. For example, if a particular method step is described, a corresponding device may contain a feature for performing the described method step, even if this feature is not explicitly described or shown in the figure. On the other hand, if, for example, a particular device is described on the basis of functional units, a corresponding method may contain one or more steps for performing the described functionality even if these steps are not explicitly described or shown in the figures. Similarly, a system may include a corresponding device feature or features for performing a particular step of the method. The features of the various exemplary aspects and embodiments described above or below may be combined, provided that something different is not explicitly stated.

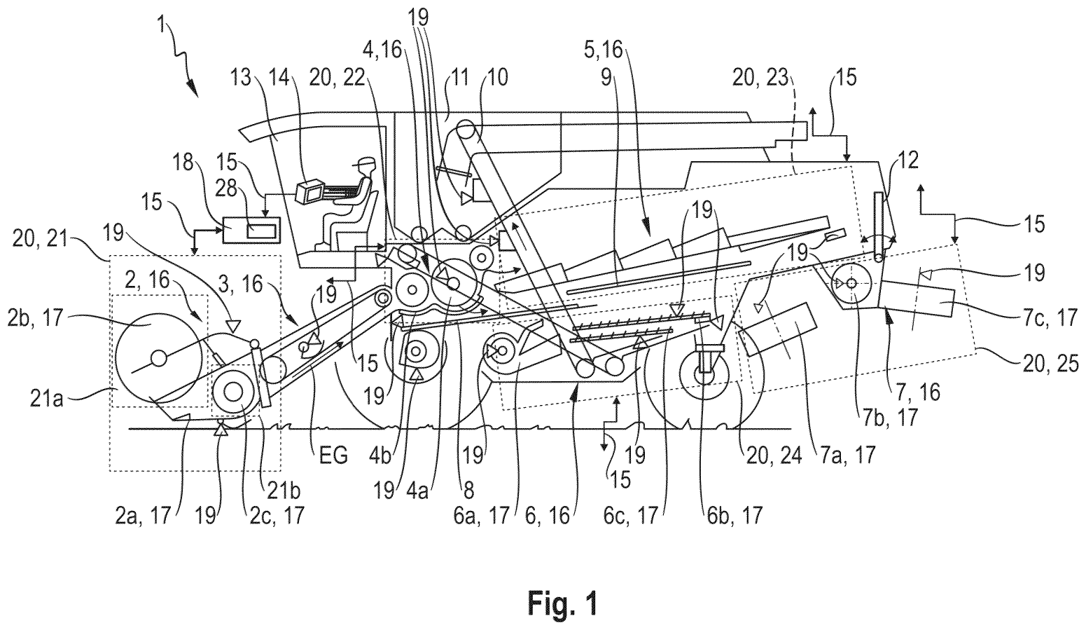

Referring to the figures, combine harvester 1, shown schematically in FIG. 1, may accommodate in its front area a front attachment designed as a cutting unit 2, which is connected to an inclined conveyor 3 of the combine harvester 1 in a manner known per se. Combine harvesters are disclosed in US Patent Application Publication No. 2023/0397533 A1, US Patent Application Publication No. 2024/0081182 A1, US Patent Application Publication No. 2024/0196796 A1, US Patent Application Publication No. 2025/0048965 A1, each of which are incorporated by reference herein in their entirety.

A harvested material flow EG passing through the inclined conveyor 3 may be transferred from the inclined conveyor 3 to a threshing device 4 of the combine harvester 1. From the threshing device 4, an emerging partial material flow of the harvested material flow EG, which may substantially contain non-grain components such as chaff and straw, may be transferred to a separating device 5 designed as a straw walker. A further partial material flow, which may substantially contain grains separated from the harvested material, may pass from the threshing device 4 to a conveyor floor 8. In one or some embodiments, the separating device 5 may also be designed as a separating rotor known per se and therefore not shown. From the separating device 5, the partial material flow of the harvested material flow EG is conveyed in such a way that free-moving grains contained in the partial material flow 5 are separated in the lower area of the separating device 5. Both the grains separated from the harvested material flow EG by the threshing device 4 and by the separating device 5 may be fed to a cleaning device 6 via a returns pan 9 and conveyor floor 8. From the cleaning device 6, a cleaned grain flow finally reaches a grain tank 11 of the combine harvester 1 by means of a conveyor apparatus 10.

A chopping and distribution apparatus 7 may be arranged or positioned in the rear area of the separating device 5 designed as a straw walker. Straw leaving the separating device 5 in its rear area may be fed to the chopping and distributing device 7, which may be deposited directly on the ground in a swath or comminuted up by the chopping and distributing device 7 and spread on the ground, such as distributed substantially across the width of the front attachment 2. A so-called straw flap 12 may be provided for depositing the straw on the ground, by which the straw may be deflected past the chopping and distribution apparatus 7.

The front attachment 2 designed as a grain header may comprise an oscillatingly-driven cutterbar 2a, a variable-position reel 2b and a feed auger 2c. The threshing device 4 may comprise at least one threshing drum 4a, which may be rotatably driven at a variable speed and is encased partially at the bottom by at least one threshing concave 4b. The threshing device 4 may be designed as a multi-drum threshing unit. The distance between the threshing concave 4b and the at least one threshing drum 4a may be varied. The opening width of the threshing concave 4b may be varied. The cleaning device 6 may include a rotational-speed variable fan 6a, a variable-inclination sieve assembly with at least one top sieve 6b and one bottom sieve 6c. The top sieve 6b and the bottom sieve 6c may be driven in an oscillating manner and have sieve openings with variable opening widths. The chopping and distribution apparatus 7 comprises a chaff conveyor 7a, a rotational-speed variable chopping apparatus 7b as well as a distribution apparatus 7c. The distribution apparatus 7c may be designed as a radial distributor. The chopping apparatus 7b may comprise a rotationally-driven cutter drum and a variable-position opposing blade assembly. The chaff conveyor apparatus 7a may be operated as a chaff throwing fan which feeds the chaff to the distribution apparatus 7c to be distributed together with the chopped straw by the distribution apparatus 7c, or as a chaff distribution fan which distributes the chaff directly on the ground.

The front attachment 2, the threshing device 4, the separating device 5, the cleaning device 6, and the chopping and distributing device 7 are generally referred to below as working units 16, which, in one or some embodiments, may serve to perform working unit-specific sub-work processes of an overall work process. The components 2a, 2b, 2c, 4a, 4b, 6a, 6b, 6c, 7a, 7b, 7c of the working units 16, which are not listed exhaustively, are hereinafter generally referred to as harvested material treatment means 17. In this regard, any one, any combination, or all of components 2a, 2b, 2c, 4a, 4b, 6a, 6b, 6c, 7a, 7b, 7c of the working units 16 may comprise the harvested material treatment means 17.

Furthermore, the combine harvester 1 may include a driver's cab 13 in which at least one graphical user interface 14 (e.g., a touchscreen) is arranged or positioned and which may be connected to a bus system 15 of the combine harvester 1. A driver assistance system 18 may communicate with the graphical user interface 14 and a plurality of sensor systems 19 via the bus system 15 in a manner known per se. Details with respect to the structure of the sensor systems 19 are described in detail in U.S. Pat. No. 6,863,604, the entire content of which is hereby incorporated by reference herein in its entirety so that the structure of the sensor systems 19 will not again be described in the following.

In particular, the sensor system 19 may comprise any one, any combination, or all of a separation loss sensor, a cleaning loss sensor, a broken grain sensor, or a threshing loss sensor.

The driver assistance system 18 may be configured to automatically control the working units 16, and configured to assist an operator of the combine harvester 1 in optimizing the setting of the working units 16, taking into account harvesting conditions.

The driver assistance system 18 may comprise a memory (such as memory 26) for saving data and a computing device (such as computing device 27) for processing the data saved in the memory. The driver assistance system 18 and the working units may form a setting machine 20, in that a plurality of selectable harvesting process strategies are saved in the memory, and in that the computing device is configured to autonomously determine at least one setting parameter for implementing the selected harvesting process strategy and to automatically specify it to the working units (e.g., individually or as a whole).

The plurality of machines (e.g., a front attachment machine 21, a threshing machine 22, a separating machine 23, a cleaning machine 24, and a distribution machine 25) may be automatically configured. The front attachment machine 21 may also comprise two sub-machines, a reel machine 21a which is configured to control the reel 2b, and a feed machine 21b which is configured to control the feed auger 2c.

In one or some embodiments, the setting machine may take over the tasks of the plurality of machines. The setting machine may therefore be understood as a standardization of a plurality of machines. Sub-work processes of the front attachment 2 may be the acceptance of the material by the reel 2b and the discharge of the harvested material flow EG by the feed auger 2c. Sub-work processes of threshing device 4, separating device 5, cleaning device 6, and chopping and distributing device 7 may accordingly be the threshing, separating, cleaning and chopping and distributing of the harvested material flow EG.

The combine harvester 1 may also have an actuator system 29 with a plurality of actuators 30. The actuators 30 may each be part of one of the working units 16 or be embedded in the working units 16. For example, one of the actuators 30 is a hydraulic motor that drives the threshing drum 4a of the combine harvester 1. The plurality of actuators 30 may be connected to (e.g., in communication with) the setting machine 20. In one or some embodiments, one of the working units 16 may be controlled using at least one actuator 30.

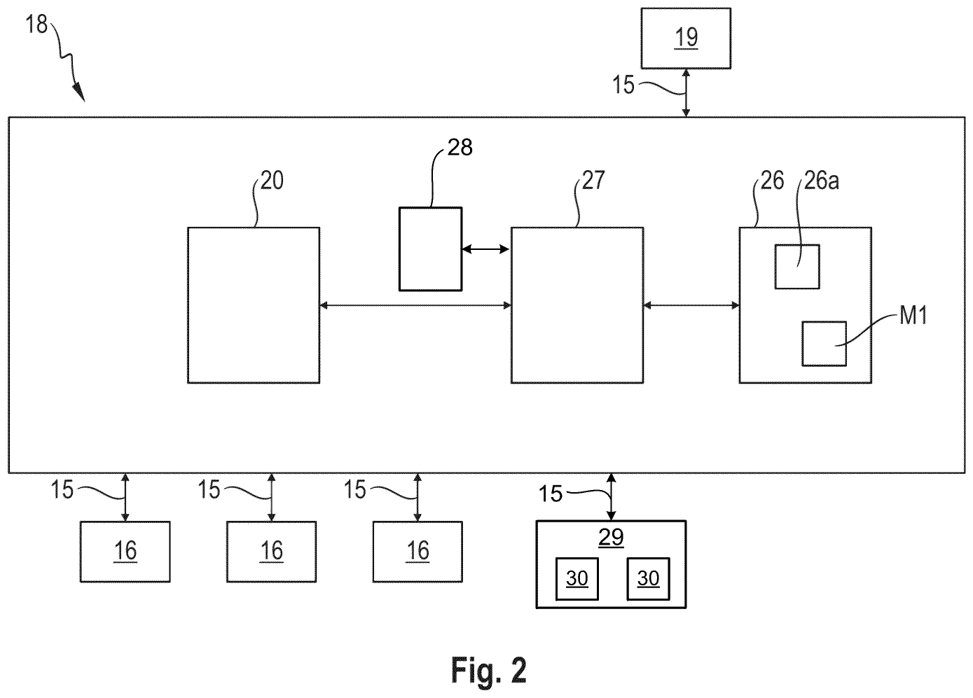

FIG. 2 schematically illustrates the functional principle of the driver assistance system 18. The driver assistance system 18 and the working units 16 may form a setting machine 20 in that a plurality of selectable harvesting process strategies 26a are saved in the memory 26, and in that the computing device 27 is configured to autonomously determine at least one setting parameter for automatically implementing the selected harvesting process strategy 26a and to automatically specify it to the working units 16 as a whole.

In one or some embodiments, computing device 27 may comprise at least one processor and may work with memory 26. Moreover, at least one communication interface 28 may be configured to communicate with devices external to the driver assistance system 18, such as via bus system 15. Communication via the communication interface 28 may be wired and/or wireless.

Computing device 27 and memory 26 may be in communication (e.g., wired and/or wirelessly) with one another. In one or some embodiments, computing device 27 may comprise a microprocessor, controller, PLA, or the like. Similarly, the memory 26 may comprise any type of storage device (e.g., any type of memory, such as RAM, ROM, or a combination thereof). Though computing device 27 and the memory 26 are depicted as separate elements, they may be part of a single machine, which includes a microprocessor (or other type of controller) and a memory. Alternatively, the computing device 27 may rely on the memory 26 for all of its memory needs. The memory 26 may comprise a tangible computer-readable medium that include software that, when executed by the computing device 27 is configured to perform any one, any combination, or all of the functionality described herein.

The computing device 27 and the memory 26 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Data detected by the sensor system 19 from the individual working units 16 or their harvested material treatment means 17 may be transmitted to the setting machine 20 via the bus system 15 and therefore made available. The setting machine 20 may generate one or more output variables, which may be used to change the setting parameters of the working units 16 or their harvested material treatment means 17.

The harvesting process strategies 26a may be displayed and selected via the graphical user interface 14 (e.g., via touchscreen). Selectable harvesting process strategies 26a may include, for example, any one, any combination, or all of achieving a maximum throughput, a quality of the processed harvested material to be achieved in terms of cleanliness, broken grain portion, or efficient operation of the combine harvester 1.

An overall model M1 per target variable may be saved in the memory 26. In so doing, the overall model M1 may form functional relationships between the target variable and one or a plurality of influencing variables. The computing device 27 may, for example, be configured to perform the autonomous determination of at least one setting parameter based on the overall model M1.

Based on the functional relationship of the overall model M1, the setting parameters of the working units 16 which enable the target of the harvesting process strategy 26a to be achieved may be inferred by the setting machine 20 depending on the different operating situations.

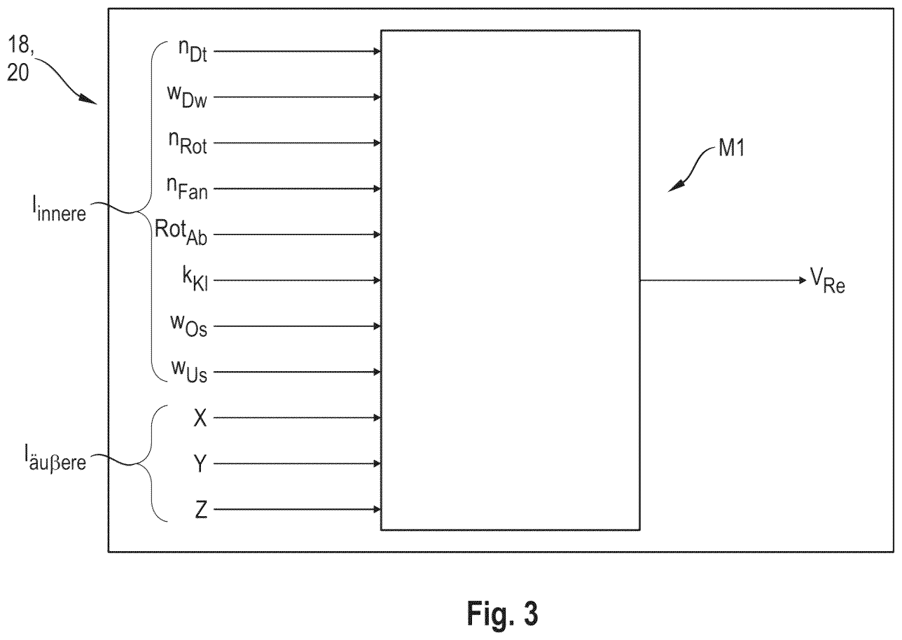

FIG. 3 schematically illustrates the functional principle of the setting machine 20. The setting machine 20 may be configured to control the working units 16 of the combine harvester 1 as a whole. In so doing, the driver assistance system 18 may form the setting machine 20 for example with the threshing device 4, the separating device 5 and the cleaning device 6.

The overall control of the working units 16 may be performed in that using the setting machine 20, all the setting parameters may be determined with which the working units 16 (e.g., the threshing device 4, the separating device 5 and the cleaning device 6) may be set.

As discussed above, the overall model M1 per target variable may be saved in the memory 26. The overall model M1 may form functional relationships between the target variable and several influencing variables.

The overall model M1 of the setting machine 20 may have internal influencing variables Iᵢₙₜₑᵣₙₐₗ and external influencing variables Iₑₓₜₑᵣₙₐₗ as influencing variables.

The internal influencing variables Iᵢₙₜₑᵣₙₐₗ may include one or a plurality working unit parameters. The working unit parameters may include any one, any combination, or all of a threshing drum rotational speed n_{Dt}, a threshing concave width w_{Dw}, a rotor rotational speed n_{Rot}, a fan rotational speed n_{Fan}, a position of a rotor cover Rot_{Ab}, a position of a flap opening k_{Kl}, a position of a top sieve w_{Os} and a position of a bottom sieve w_{Us}.

The external influencing variables Iₑₓₜₑᵣₙₐₗ may include one or a plurality working unit parameters. In particular, the harvested material parameters may comprise any one, any combination, or all of a crop density X, a threshability Y and a crop moisture Z.

The overall model M1 of the setting machine 20 may have a cleaning loss V_{Re} as the only target variable. The single target variable may be calculated based on the influencing variable(s) and the overall model M1. One of skill in the art knows that the setting machine 20 may comprise additional overall models for each target variable. For example, an overall model may have a separation loss V_{Ab}, an overflow volume Uek_{Vol} or a grain fraction overflow Uek_{Korn} as a target variable.

In its simplest form, the overall model M1 may be a regression model:

$${Y}_{i} = f ( {X}_{i} , β ) + {ε}_{i}$$

where Yᵢ is a function of Xᵢ and β, and where this relationship is superimposed by an additive disturbance variable εᵢ which may represent unmodeled or unknown determinant factors of Yᵢ.

In a first step, the setting machine 20 may be trained using a computer-implemented method. The training of the setting machine 20 may take place before starting up the combine harvester 1. It is also contemplated for the setting machine 20 of the combine harvester 1 to be adapted or retrained dynamically during operation.

First of all, training data, including measured values for the influencing variables and the target variables, may be detected. The setting machine 20 may be trained by minimizing a loss function. The loss function may, for example, be formed by the root mean square error (RSME) according to the following:

$$RMSE ( y , \hat{y} ) = \sqrt{\frac{{\sum }_{i = 0}^{N - 1} {( {y}_{i} - {\hat{y}}_{l} )}^{2}}{N}}$$

where N stands for the total number of data points in the data set or training data set, yᵢ denotes a single value of the ith data point in the data set, and ŷᵢ is the prediction that the overall model M1 has made for the ith data point.

Accordingly, the loss function in the form of the RMSE may be based on a target value of the setting machine 20 and the training data. The result of the training may be a set of estimated coefficients ¿ of the overall model M1, which may also be determined in the simplest form using:

$$\hat{c} = {( {X}^{T} X )}^{- 1} {X}^{T} y$$

In a second step, the operating point of a combine harvester 1 may be optimized using the setting machine 20. For this purpose, a computer-implemented method may be used in which setting parameters are determined based on the trained setting machine 20.

For example, the trained overall model M1 of the setting machine 20 may be used to calculate a minimum or minimum value for the cleaning loss V_{Re}. The calculation may produce, for example, the values for the influencing variable(s) (e.g., any one, any combination, or all of threshing drum rotational speed n_{Dt}, threshing concave width w_{Dw}, rotor rotational speed n_{Rot}, fan rotational speed n_{Fan}, position of a rotor cover Rot_{Ab}, position of a flap opening k_{Kl}, position of a top sieve w_{Os}, position of a bottom sieve w_{Us}, harvested material density X, threshability Y and crop moisture Z at which the cleaning loss V_{Re} assumes a minimum value). The setting parameters may, for example, be determined in such a way that the influencing variables of the setting machine are varied. In so doing, the influencing variables may be minimized until the target variable, for example, the cleaning loss V_{Re} assumes a predetermined minimum value. The determined values of the influencing variables may be used as setting parameters for the working units 16.

The computer-implemented method may automatically control the working units 16 of the combine harvester 1 based on the setting parameters. This may mean that the influencing variables for which a minimum or a minimum value for the cleaning loss V_{Re} has been calculated are transmitted to the threshing device 4, the separating device 5 and the cleaning device 6 in order to perform the automatic control. In turn, this may allow an operating point of the combine harvester 1 to be optimized.

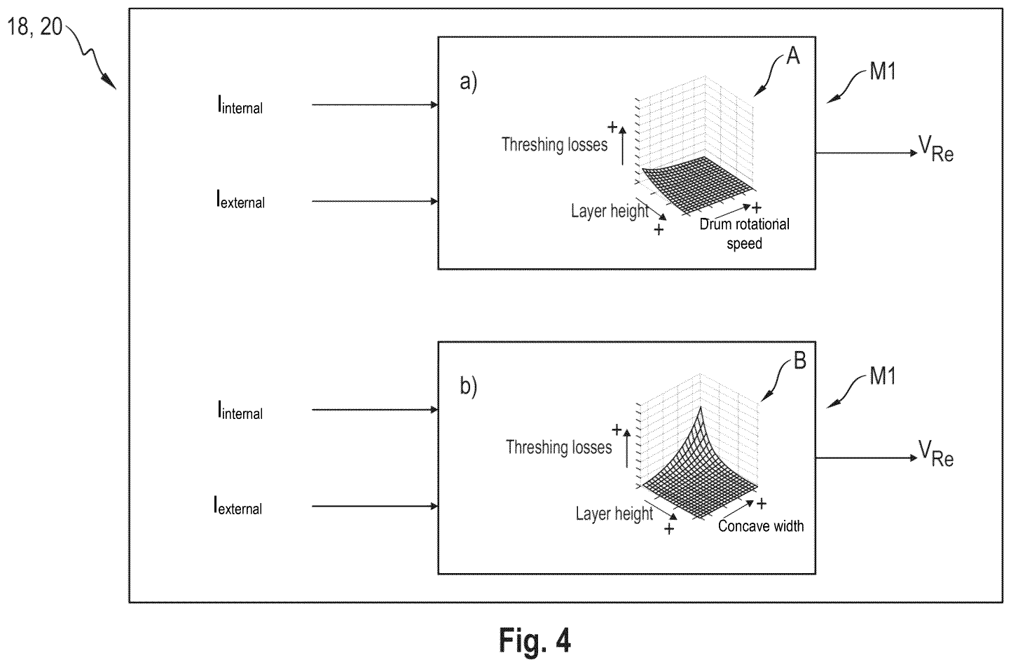

FIG. 4 schematically shows the functional principle of the setting machine 20 with a plurality of overall models M1, M2. In this case, the setting machine 20 comprises an overall model M1 for the cleaning loss V_{Re} and a further overall model M2 for the separation loss V_{Ab}. Both overall models M1 and M2 have internal influencing variables Iᵢₙₜₑᵣₙₐₗ and external influencing variables/external.

The overall model M1 may be formed by a characteristic curve field A, and the overall model M2 may be formed by a characteristic curve field B. The target variable may be assigned to at least one characteristic curve field for mapping the functional relationships. The target variable may be formed on the basis of an output variable of the at least one characteristic curve field.

The data detected by the sensor systems 19 may be used for the cyclical adaptation of the characteristic curve fields A, B.

It is contemplated that an overall target variable G may be formed using the two overall models M1, M2, such as according to:

$$G ( {V}_{Re} , {V}_{A b} ) = {V}_{R e} + {V}_{A b}$$

If the overall target variable G is minimized, influencing variables may be determined for which the two losses, cleaning loss V_{Re} and separation loss V_{Ab}, are as low as possible. The determined influencing variables may in turn be used as setting parameters for the working units 16.

In one or some embodiments, the setting machine 20 comprises additional overall models. For example, the setting machine may have a total of 8 overall models, each of which may serve to calculate a single target variable.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Combine harvester |
| 2 | Front attachment |
| 2a | Cutter bar |
| 2b | Reel |
| 2c | Feed auger |
| 3 | Inclined conveyor |
| 4 | Threshing device |
| 4a | Threshing drum |
| 4b | Threshing concave |
| 5 | Separating device |
| 6 | Cleaning device |
| 6a | Fan |
| 6b | Top sieve |
| 6c | Bottom sieve |
| 7 | Chopping and distribution apparatus |
| 7a | Chaff conveyor apparatus |
| 7b | Chopping apparatus |
| 7c | Distribution apparatus |
| 8 | Conveyor floor |
| 9 | Returns pan |
| 10 | Conveying device |
| 11 | Grain tank |
| 12 | Straw flap |
| 13 | Driver's cab |
| 14 | User interface |
| 15 | Bus system |
| 16 | Working unit |
| 17 | Harvested material handling means |
| 18 | Driver assistance system |
| 19 | Sensor system |
| 20 | Setting machine |
| 21 | Front attachment machine |
| 21a | Reel machine |
| 21b | Feed machine |
| 22 | Automated threshing unit |
| 23 | Separating machine |
| 24 | Cleaning machine |
| 25 | Distribution machine |
| 26 | Memory |
| 26a | Harvesting process strategy |
| 27 | Computer device |
| 28 | Communication interface |
| n_{Dt} | Threshing drum rotational speed |
| w_{Dw} | Threshing concave width |
| n_{Rot} | Rotor rotational speed |
| n_{Fan} | Fan speed |
| Rot_{Ab} | Position of a rotor cover |
| k_{Kl} | Position of a flap opening |
| w_{Os} | Position of a top sieve |
| w_{Us} | and position of a bottom sieve |
| X | Crop density |
| Y | Threshability |
| Z | Crop moisture |
| EC | Harvested material flow |
| V_{Re} | Cleaning loss |
| V_{Ab} | Separation loss |
| Uek_{Vol} | Overflow volume |
| Uek_{Korn} | Grain fraction overflow |
| M2 | Overall model |
| G | Overall target variable |
| 29 | Actuator system |
| 30 | Actuators |

1. A combine harvester comprising:
a plurality of working units;
a driver assistance system configured to control the plurality of working units, wherein the driver assistance system comprises: (i) a memory configured to save data, a plurality of selectable harvesting process strategies; and an overall model per target variable; and (ii) a computing device configured to process the data saved in the memory; the plurality of working units together with the driver assistance system form a setting machine;
wherein the overall model forms functional relationships between a respective target variable and a plurality of influencing variables, wherein the plurality of influencing variables comprise internal influencing variables and external influencing variables;
wherein the computing device is configured to:
autonomously determine, based on the overall model, at least one setting parameter for implementing a selected harvesting process strategy; and
autonomously specify the selected harvesting process strategy to one or more of the plurality of working units in order to autonomously control one or more of the plurality of working units.

2. The combine harvester of claim 1, wherein the selectable harvesting process strategies address a target specification of setting or optimization of a respective target variable; and
wherein the respective target variable comprises one or more of: threshing losses; broken grain portion; separation losses; cleaning losses; threshing unit drive slip; or fuel consumption.

3. The combine harvester of claim 2, wherein the respective target variable is assigned to at least one characteristic curve field for mapping the functional relationships; and
wherein the respective target variable is formed based on an output variable of the at least one characteristic curve field.

4. The combine harvester of claim 1, wherein the internal influencing variables comprise one or more working unit parameters; and
wherein the one or more working unit parameters are formed as one or more of the following: a threshing drum rotational speed; a threshing concave width; a rotor rotational speed;
a fan rotational speed; a position of a rotor cover; a position of a flap opening; a position of a top sieve; or a position of a bottom sieve.

5. The combine harvester of claim 1, wherein the external influencing variables comprise one or more harvested material parameters; and
wherein the one or more harvested material parameters are formed as one or more of the following: a crop density; threshability; or a crop moisture.

6. The combine harvester of claim 1, wherein the overall model is based on a regularized model.

7. The combine harvester of claim 1, further comprising an actuator system that includes a plurality of actuators;
wherein the plurality of actuators are connected to the setting machine; and
wherein at least one of the plurality of actuators is configured to control at least one of the plurality of working units.

8. The combine harvester of claim 1, wherein the computing device is further configured to cyclically adjust the overall model to a current harvesting process state during harvesting mode.

9. The combine harvester of claim 8, further comprising a sensor array configured to detect sensor data indicative of the current harvesting process state; and
wherein the computing device, based on the sensor data, is configured to determine the current harvesting process state.

10. The combine harvester of claim 9, wherein the sensor array comprises one or more of a separation loss sensor, a cleaning loss sensor, a broken grain sensor, or a threshing loss sensor.

11. The combine harvester of claim 1, wherein the plurality of working units comprise a threshing device, a separating device, and a cleaning device; and
wherein the driver assistance system forms the setting machine with the threshing device, the separating device, and the cleaning device.

12. A method for operating a combine harvester, the method comprising:
operating the combine harvester that a plurality of working units and a driver assistance system, the driver assistance system control the plurality of working units and comprises: (i) a memory configured to save data, a plurality of selectable harvesting process strategies; and an overall model per target variable; and (ii) a computing device configured to process the data saved in the memory; wherein the plurality of working units together with the driver assistance system form a setting machine; wherein the overall model forms functional relationships between a respective target variable and a plurality of influencing variables, wherein the plurality of influencing variables comprise internal influencing variables and external influencing variables;
autonomously determining, based on the overall model, at least one setting parameter for implementing a selected harvesting process strategy; and
autonomously specifying the selected harvesting process strategy to one or more of the plurality of working units in order to autonomously control one or more of the plurality of working units.

13. The method of claim 12, wherein the selectable harvesting process strategies address a target specification of setting or optimization of a respective target variable; and
wherein the respective target variable comprises one or more of: threshing losses; broken grain portion; separation losses; cleaning losses; threshing unit drive slip; or fuel consumption.

14. The method of claim 13, wherein the respective target variable is assigned to at least one characteristic curve field for mapping the functional relationships; and
wherein the respective target variable is formed based on an output variable of the at least one characteristic curve field.

15. The method of claim 12, further comprising cyclically adjusting the overall model to a current harvesting process state during harvesting mode.

16. The method of claim 15, wherein the combine harvester further includes a sensor array configured to detect sensor data indicative of the harvesting process state; and
wherein the current harvesting process state is determined based on the sensor data.

17. The method of claim 16, wherein the sensor array comprises one or more of a separation loss sensor, a cleaning loss sensor, a broken grain sensor, or a threshing loss sensor.
